(19) United States
(12) Patent Application Publication
(10) Pub. No.: US 2025/0304039 A1
(43) Pub. Date: Oct. 2, 2025

(54) CONTROL DEVICE, CONTROL METHOD, AND STORAGE MEDIUM

(71) Applicant: HONDA MOTOR CO., LTD., Tokyo (JP)

(72) Inventor: Masashi KANESAKA, Tokyo (JP)

(73) Assignee: HONDA MOTOR CO., LTD., Tokyo (JP)

(21) Appl. No.: 19/066,175

(22) Filed: Feb. 28, 2025

(30) Foreign Application Priority Data
Mar. 27, 2024 (JP) 2024-051265

(51) Int. Cl. B60W 30/06; B60W 50/14; E05B 77/54; G06V 20/56

(52) U.S. Cl. CPC B60W 30/06; B60W 50/14; E05B 77/54; G06V 20/56; B60W 2050/146; B60W 2420/403; B60W 2420/408; B60W 2420/54; B60W 2540/215

(57) ABSTRACT

A control device for automatically parking a vehicle to a predetermined parking position, the control device includes: an acquisition unit configured to acquire peripheral information of the vehicle; a reception unit configured to receive designation of the parking position from a user of the vehicle; and a control unit configured to automatically move the vehicle to the parking position based on the acquired peripheral information and the designated parking position. The control unit temporarily stops the vehicle and sets a door of the vehicle to an openable state from an unopenable state in response to s a vehicle stop request from the user of the vehicle while the vehicle is being moved to the parking position, and resumes moving the vehicle to the parking position in response to a predetermined operation being received from the user of the vehicle.

This application is based upon and claims the benefit of priority from prior Japanese patent application No. 2024-51265, filed on Mar. 27, 2024, the entire contents of which are incorporated herein by reference.

### TECHNICAL FIELD

The present disclosure relates to a control device, a control method, and a storage medium storing a control program.

### BACKGROUND ART

In recent years, active efforts have been made to provide access to a sustainable transportation system in consideration of vulnerable traffic participants. As one of these efforts, research and development on driving assistance techniques and automated driving techniques for vehicles such as automobiles have been made in order to further improve safety and convenience of traffic.

For example, in the related art, a device that performs parking assistance control for automatically moving a vehicle to a parking area is known. As an example of such a device, JP2018-203214A below discloses a technique for assisting, when a driver designates a parking-allowed frame indicating a parking area on a touch panel, parking to the parking area.

### SUMMARY OF INVENTION

However, in the related art, for example, when a vehicle is being automatically moved to a parking area (or a parking position), an event of an occupant getting off the vehicle or the like is not considered, and there is a room for improvement in this regard.

Aspects of the present disclosure relate to providing a control device, a control method, and a storage medium storing a control program allowing an occupant to get off a vehicle when the vehicle is being automatically moved to a parking area, and enabling resumption of the automatic parking.

According to an aspect of the present disclosure, there is provided a control device for automatically parking a vehicle to a predetermined parking position, the control device including:
an acquisition unit configured to acquire peripheral information of the vehicle;
a reception unit configured to receive designation of the parking position from a user of the vehicle; and
a control unit configured to automatically move the vehicle to the parking position based on the acquired peripheral information and the designated parking position, in which
the control unit temporarily stops the vehicle and sets a door of the vehicle to an openable state from an unopenable state in response to s a vehicle stop request from the user of the vehicle while the vehicle is being moved to the parking position, and resumes moving the vehicle to the parking position in response to a predetermined operation being received from the user of the vehicle.

According to another aspect of the present disclosure, there is provided a control method, using a computer, for automatically parking a vehicle to a predetermined parking position, the control method including:
acquiring peripheral information of the vehicle;
receiving designation of the parking position from a user of the vehicle;
automatically moving the vehicle to the parking position based on the acquired peripheral information and the designated parking position;
temporarily stopping the vehicle and setting a door of the vehicle to an openable state from an unopenable state in response to a vehicle stop request from the user of the vehicle while the vehicle is being moved to the parking position; and
resuming moving the vehicle to the parking position in response to a predetermined operation being received from the user of the vehicle.

According to another aspect of the present disclosure, there is provided a non-transitory computer-readable storage medium storing a control program causing a computer to execute a process for automatically parking a vehicle to a predetermined parking position, the process including:
acquiring peripheral information of the vehicle;
receiving designation of the parking position from a user of the vehicle; and
automatically moving the vehicle to the parking position based on the acquired peripheral information and the designated parking position;
temporarily stopping the vehicle and setting a door of the vehicle to an openable state from an unopenable state in response to a vehicle stop request from the user of the vehicle while the vehicle is being moved to the parking position; and
resuming moving the vehicle to the parking position in response to a predetermined operation being received from the user of the vehicle.

According to aspects of the present disclosure, when the vehicle is being automatically moved to a parking area, an occupant may get off the vehicle and the automatic parking can be resumed. This may further improve traffic safety and contributes to development of a sustainable transportation system.

### BRIEF DESCRIPTION OF DRAWINGS

Exemplary embodiment(s) of the present invention will be described in detail based on the following figures, wherein:

FIG. 1 is a block diagram showing a schematic configuration of a vehicle 1 equipped with a control device 30 according to an embodiment; and

FIG. 2 is a flowchart showing an example of processing (parking assistance processing) performed by the control device 30 according to the embodiment.

### DESCRIPTION OF EMBODIMENTS

Hereinafter, an embodiment of a vehicle control device according to the present disclosure will be described with reference to the drawings. The following embodiment does not limit the present disclosure, and not all elements described in the following embodiment are essential to the present disclosure. Further, two or more elements described in the following embodiment may be freely combined without departing from the gist of the present disclosure. Hereinafter, the same or similar elements are denoted by the same or similar reference signs, and a description thereof may be omitted or simplified.

### Vehicle Equipped With Control Device

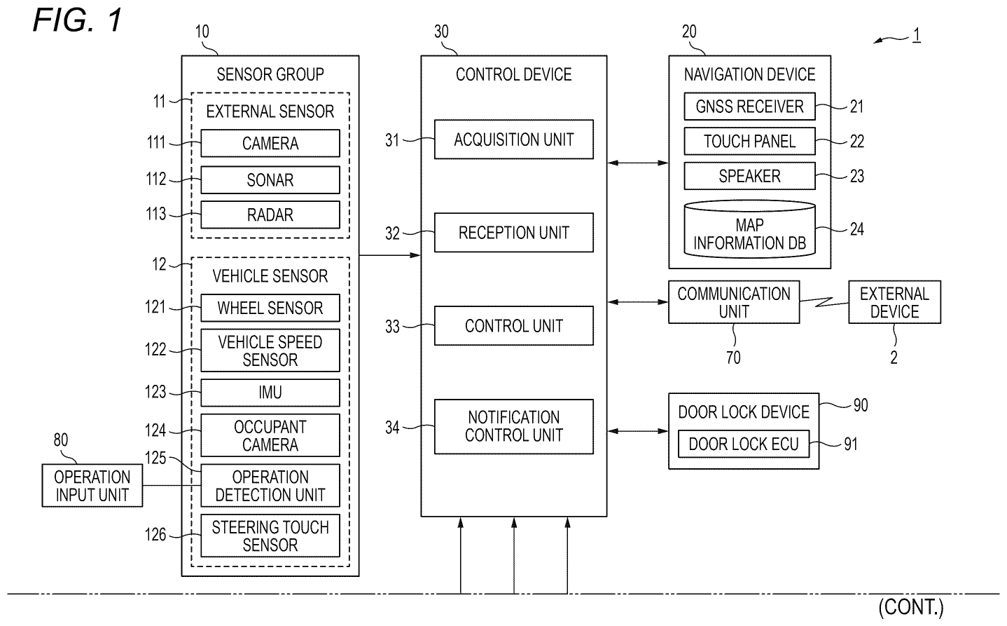

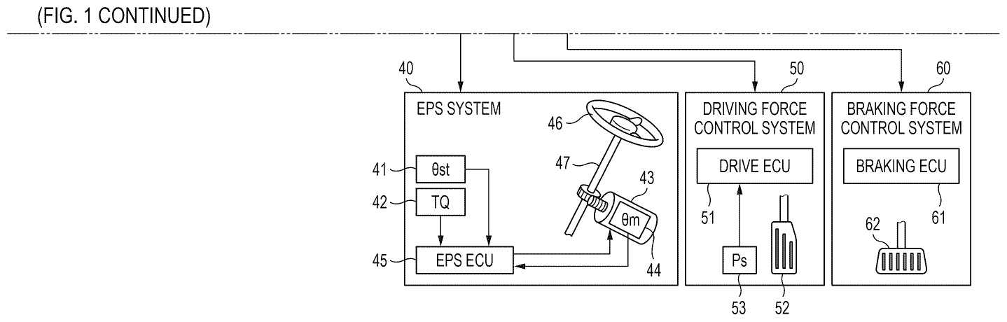

First, a vehicle of the present embodiment will be described. FIG. 1 is a block diagram showing a configuration of a vehicle 1 equipped with a control device 30 according to the embodiment. The vehicle 1 is an automobile including a drive source (not shown) and wheels including drive wheels driven by power of the drive source and steerable steered wheels. As an example, the vehicle 1 can be a four-wheeled automobile including a pair of left and right front wheels and a pair of left and right rear wheels.

The drive source of the vehicle 1 may be an electric motor, an internal combustion engine such as a gasoline engine or a diesel engine, or a combination of an electric motor and an internal combustion engine. The drive source of the vehicle 1 may drive the pair of left and right front wheels, the pair of left and right rear wheels, or four wheels including the pair of left and right front wheels and the pair of left and right rear wheels. Either the front wheels or the rear wheels of the vehicle 1 may be steerable steered wheels, or the front wheels and the rear wheels may all be steerable steered wheels.

In the vehicle 1, automated driving and driving assistance in which a driving operation is autonomously controlled to cause the vehicle 1 to travel are possible. The automated driving defined here refers to a system of the vehicle performing all driving operations such as recognizing or monitoring a travel environment and peripheral information (surrounding situations), as well as starting, accelerating/decelerating, steering, and stopping. Further, the driving assistance refers to a system of the vehicle performing a part of driving operations such as starting, accelerating/decelerating, steering, and stopping, and is, for example, an automatic parking system (APS), a lane keep assist system (LKAS), and adaptive cruise control (ACC). In the embodiment to be described below, a case where the vehicle 1 is automatically parked to a predetermined parking area or parking position will be described as an example.

The vehicle 1 includes a sensor group 10, a navigation device 20, the control device 30, an electric power steering (EPS) system 40, a driving force control system 50, a braking force control system 60, a communication unit 70, an operation input unit 80, and a door lock device 90.

The sensor group 10 includes an external sensor 11 that acquires information related to surroundings of the vehicle 1, and a vehicle sensor 12 that acquires information related to the vehicle 1. Information (in other words, detection values) acquired by each sensor in the sensor group 10 is output to the control device 30.

The external sensor 11 includes, for example, a camera 111, a sonar 112, and a radar 113. The camera 111 is a digital camera that images the surroundings of the vehicle 1 including the front of the vehicle 1 and outputs image data of an obtained peripheral image to the control device 30. As the camera 111, for example, a digital camera using an imaging element such as a charge coupled device (CCD) or a complementary metal oxide semiconductor (CMOS) can be adopted.

The sonar 112 emits sound waves around the vehicle 1 (for example, a front, a rear, and lateral sides of the vehicle 1), and receives reflected sounds from an object present around the vehicle 1, thereby detecting a distance to the object, a direction of the object, and the like. The radar 113 emits radio waves around the vehicle 1 including the front of the vehicle 1, and receives reflected waves from an object present around the vehicle 1, thereby detecting a distance to the object, a direction of the object, and the like. As the radar 113, for example, a millimeter wave radar can be adopted.

The external sensor 11 may include light detection and ranging (LiDAR) instead of or in addition to the sonar 112 and the radar 113. In this case, the LiDAR emits laser light around the vehicle 1 including the front of the vehicle 1, and receives reflected light from an object present around the vehicle 1, thereby detecting a distance to the object, a direction of the object, and the like.

The vehicle sensor 12 includes, for example, a wheel sensor 121, a vehicle speed sensor 122, an inertial measurement unit (IMU) 123, an occupant camera 124, an operation detection unit 125, and a steering touch sensor 126.

The wheel sensor 121 detects a rotation angle of one or more wheels among the wheels of the vehicle 1. As an example, the wheel sensor 121 detects a rotation angle of each of a left rear wheel and a right rear wheel. As the wheel sensor 121, for example, an angle sensor or a displacement sensor can be adopted.

The vehicle speed sensor 122 detects a vehicle speed, which is a travel speed of the vehicle 1 (in other words, a movement speed of a vehicle body). For example, the vehicle speed sensor 122 detects the vehicle speed based on the number of revolutions of a countershaft (not shown) in the vehicle 1.

The inertial measurement unit 123 detects angular velocities of the vehicle 1 in a pitch direction, a roll direction, and a yaw direction, and accelerations of the vehicle 1 in a front-rear direction, a left-right direction, and an upper-lower direction. The vehicle sensor 12 may include, instead of the inertial measurement unit 123, an acceleration sensor that detects an acceleration of the vehicle 1 in a predetermined direction and a gyro sensor that detects an angular velocity of the vehicle 1 in a predetermined direction.

The occupant camera 124 is a digital camera that images a vehicle interior of the vehicle 1 and outputs image data of an obtained vehicle interior image to the control device 30. For example, the occupant camera 124 can be a “driver monitor camera” that is provided to be able to image a head of a driver sitting in a driver seat of the vehicle 1 from the front (in other words, to image a face). Similarly to the camera 111, a digital camera using an imaging element such as a CCD or a CMOS can be adopted as the occupant camera 124. In the present embodiment, the image data of the vehicle interior image obtained by the occupant camera 124 imaging the vehicle interior is information that can specify an orientation of a line of sight of the driver.

The operation detection unit 125 detects an operation performed using the operation input unit 80 which is provided to be operable by occupants including the driver. In the present embodiment, the operation input unit 80 includes, for example, an operation switch (not shown) that accepts an operation for switching automatic parking to be described later between on (in other words, to be activated) and off (in other words, to be deactivated). In this case, the operation detection unit 125 can detect the operation for turning on/off the automatic parking. Further, the operation input unit 80 may include, for example, a door (not shown) to be operated when the occupant gets off the vehicle 1. In this case, the operation detection unit 125 can detect a door operation such as pulling a door handle by the occupant.

The steering touch sensor 126 detects whether a steering 46 of the vehicle 1 is appropriately gripped. For example, the steering touch sensor 126 is implemented by a capacitance sensor or the like. In this case, the capacitance sensor is provided at a portion where the driver touches the steering 46 when the steering 46 is appropriately gripped.

The navigation device 20 includes, for example, a global navigation satellite system (GNSS) receiver 21, a touch panel 22, and a speaker 23. The navigation device 20 includes a storage unit (not shown) implemented by a flash memory or the like. The storage unit of the navigation device 20 stores a map information database (DB) 24 and the like.

The GNSS receiver 21 specifies a current position of the vehicle 1 (for example, a latitude and longitude of a point where the vehicle 1 is located) based on signals received from GNSS satellites. For example, the navigation device 20 may acquire a detection result of the vehicle sensor 12 (for example, the wheel sensor 121 or the vehicle speed sensor 122) via the control device 30, and specify or complement the current position of the vehicle 1 by an inertial navigation system (INS) using a detection value of the vehicle sensor 12.

The touch panel 22 functions as an input device that receives input of various types of information for the control device 30 and as a display device controlled by the control device 30. The touch panel 22 is implemented by combining a display device such as a liquid crystal display or an organic light emitting diode (OLED) with a pointing device (for example, a touch pad). The speaker 23 is configured to output sound to the occupant (for example, the driver) of the vehicle 1.

For example, the navigation device 20 searches for, by referring to the map information database 24, a route from the current position of the vehicle 1 to a destination set by the driver using the touch panel 22. Then, the navigation device 20 performs route guidance using the touch panel 22 and the speaker 23 based on the route searched for. The navigation device 20 may cause the touch panel 22 to perform a predetermined display according to an instruction from the control device 30. The specific display will be described later. Further, the navigation device 20 may output, to the control device 30, predetermined information such as information indicating a specified current position of the vehicle 1 or information indicating an operation received via the touch panel 22.

The control device 30 is a computer that includes, for example, a processor for performing various calculations, a storage unit having a non-transitory storage medium for storing various kinds of information, and an input and output unit that controls input and output of data between an inside and outside of the control device 30 (none of which are shown), and performs overall control on the entire vehicle 1. For example, the control device 30 is implemented by one electronic control unit (ECU) or by a plurality of ECUs working in cooperation with each other. Since the control device 30 performs the driving assistance such as controlling the vehicle on behalf of the driver, the control device 30 may also be called a control device in a so-called advanced driving assistance system (ADAS ECU). Since specific examples of the control performed by the control device 30 will be described later, the description thereof will be omitted here.

The EPS system 40 includes a steering angle sensor 41, a torque sensor 42, an EPS motor 43, a resolver 44, and an EPS ECU 45.

The steering angle sensor 41 detects a steering angle θst of the steering 46 and outputs information indicating the detected steering angle θst to the EPS ECU 45. The torque sensor 42 detects a steering torque TQ, which is a torque applied to the steering 46 of the vehicle 1, and outputs information indicating the detected steering torque TQ to the EPS ECU 45.

The EPS motor 43 assists the driver in operating the steering 46 by applying, according to an instruction from the EPS ECU 45, a driving force or a reaction force to a steering column 47 connected to the steering 46. The resolver 44 detects a rotation angle θm of the EPS motor 43 and outputs information indicating the detected rotation angle θm to the EPS ECU 45.

The EPS ECU 45 is a computer that includes, for example, a processor for performing various calculations, a storage unit including a non-transitory storage medium for storing various kinds of information, and an input and output unit that controls input and output of data between an inside and outside of the EPS ECU 45 (none of which are shown), and controls the EPS system 40 (for example, the EPS motor 43), and the EPS ECU 45 is implemented by one or more ECUs. For example, the EPS ECU 45 controls the EPS system 40 (for example, the EPS motor 43) based on the steering angle θst detected by the steering angle sensor 41, the steering torque TQ detected by the torque sensor 42, the rotation angle θm detected by the resolver 44, and the like.

The EPS system 40 (for example, the EPS ECU 45) may output, to the control device 30, information indicating the steering angle θst detected by the steering angle sensor 41, the steering torque TQ detected by the torque sensor 42, the rotation angle θm detected by the resolver 44, and the like. Further, the EPS system 40 (for example, the EPS ECU 45) may output information indicating a steering speed ω of the steering 46 to the control device 30. The steering speed ω is obtained by, for example, differentiating the steering angle θst with respect to time.

The driving force control system 50 includes a drive ECU 51, and is configured to control a driving force of the vehicle 1. The drive ECU 51 is a computer that includes, for example, a processor that performs various calculations, a storage unit having a non-transitory storage medium that stores various kinds of information, and an input and output unit that controls input and output of data between an inside and outside of the drive ECU 51 (none of which are shown), and controls the driving force control system 50, and the drive ECU 51 is implemented by one or more ECUs. For example, the drive ECU 51 controls the driving force output from the drive source of the vehicle 1 based on an amount of operation on an accelerator pedal 52 provided in the vehicle 1 and a detection value of a shift position sensor 53 that detects a shift position Ps of a shift device (for example, a shift lever or a shift switch) (not shown). As described above, the drive source is an internal combustion engine or a motor, and the drive ECU 51 controls an output of the internal combustion engine or the motor based on the amount of operation on the accelerator pedal 52 and the shift position Ps. The drive ECU 51 can also control the driving force control system 50 (for example, a drive source) according to an instruction from the control device 30.

The braking force control system 60 includes a braking ECU 61, and is configured to control a braking force of the vehicle 1. The braking ECU 61 is a computer that includes, for example, a processor that performs various calculations, a storage unit having a non-transitory storage medium that stores various kinds of information, and an input and output unit that controls input and output of data between an inside and outside of the braking ECU 61 (none of which are shown), and controls the braking force control system 60, and the braking ECU 6 is implemented by one or more ECUs. For example, the braking ECU 61 controls the braking force of the vehicle 1 by controlling a brake device (not shown) provided in the vehicle 1 based on an operation on the brake pedal 62 provided in the vehicle 1. Here, the brake device includes, for example, a brake caliper, a cylinder that transmits hydraulic pressure to the brake caliper, and an electric motor that generates hydraulic pressure in the cylinder. The braking ECU 61 controls the electric motor of the brake device to generate a braking force corresponding to the operation on the brake pedal 62. The braking ECU 61 can also control the braking force control system 60 according to an instruction from the control device 30.

The communication unit 70 is a communication interface that communicates with an external device 2 according to a control instruction from the control device 30. That is, the control device 30 may communicate with the external device 2 via the communication unit 70. Examples of the external device 2 can include a terminal device (for example, a smartphone) of the driver and a server device managed by a manufacturer of the vehicle 1. For example, a mobile communication network such as a cellular line, WI-FI (registered trademark), or Bluetooth (registered trademark) can be adopted for the communication between the vehicle 1 and the external device 2.

The door lock device 90 is a device that locks and unlocks a door of the vehicle 1 under control of the control device 30. The door lock device 90 includes a door lock ECU 91. The door lock ECU 91 is a computer that includes, for example, a processor that performs various calculations, a storage unit having a non-transitory storage medium that stores various kinds of information, and an input and output unit that controls input and output of data between an inside and outside of the door lock ECU 91 (none of which are shown), and controls the door lock device 90, and the door lock ECU 91 is implemented by one or more ECUs. For example, the door lock ECU 91 locks the door based on the vehicle speed of the vehicle 1, or unlocks the door when the shift position Ps is parking (P). When performing parking assistance processing to be described later, the door lock ECU 91 controls the door to an openable state or an unopenable state according to an instruction of the control device 30.

### Control Device

Next, the control device 30 will be described in detail. For example, the control device 30 performs various programs stored in the storage unit of the control device 30. In the present embodiment, the control device 30 is configured to perform control of automatic parking of automatically parking the vehicle 1 to a predetermined parking position (or parking area) designated by a user including the driver and other occupants of the vehicle 1 (hereinafter also referred to as the “user”) (hereinafter also referred to as “automatic parking”). That is, the control device 30 automatically performs drive control on the drive source, braking control on the brake device, and steering control on the steering 46, and performs the automatic parking with a predetermined parking position (hereinafter, also referred to as “parking position”) designated by the user as a target parking position.

Here, a basic outline of the automatic parking will be described. The automatic parking refers to that the vehicle 1 is automatically moved to the designated parking position as described above, and a trigger for starting the movement (that is, starting the automatic parking) is, for example, an operation switch for switching ON/OFF of the automatic parking and provided at a predetermined position of the vehicle 1 being operated or a display device such as the touch panel 22 being operated. The shift position Ps of the shift device when the automatic parking is to be started is set to the parking (P). When the automatic parking is performed, the shift position Ps is set to drive (D) or reverse (R) by the control device 30, and the movement of the vehicle 1 is started. When the movement of the vehicle 1 to the designated parking position is completed, the control device 30 returns the shift position Ps to the parking (P) and ends the automatic parking. The trigger for starting the above automatic parking may also be assumed to be based on other factors, such as an operation on a portable terminal such as a smartphone when the user is outside the vehicle, but in the present embodiment, the automatic parking is started by operating the operation switch provided on the vehicle 1 or operating the display device such as the touch panel 22.

Regarding the automatic parking performed in this manner, in a known related-art example, the automatic parking is cancelled in a case where the user performs an operation of opening the door of the vehicle 1 or in a case where the shift position Ps is set to the parking (P) during execution of the automatic parking. Meanwhile, during the execution of automatic parking, the user may want to get out of the vehicle depending on convenience of the user (for example, for a hurry to go to a toilet), an environment of the parking position (for example, the parking position is narrow), or the like. Therefore, in the present embodiment, in a case where there is a vehicle stop request from the user during the execution of automatic parking, the user can get out of the vehicle when a predetermined condition is satisfied. Details of the convenience of the user and the environment of the parking position will be described later.

Specifically, the control device 30 executes, as an example of the program recorded in the storage unit, a program for the parking assistance processing of assisting the automatic parking when execution of the automatic parking started by operating the operation switch in the operation input unit 80 is detected. The control device 30 includes an acquisition unit 31, a reception unit 32, a control unit 33, and a notification control unit 34, as functional units that are implemented by executing the program. In the following, processing described as being performed by the acquisition unit 31, the reception unit 32, the control unit 33 and the notification control unit 34 is processing implemented by the control device 30.

The acquisition unit 31 acquires the peripheral information of the vehicle 1. For example, the acquisition unit 31 performs sensor fusion processing on detection values of a part or all of the camera 111, the sonar 112, and the radar 113 in the external sensor 11, and acquires the peripheral information of the vehicle 1 based on a processing result. More specifically, the acquisition unit 31 recognizes a position, a type, a speed, an acceleration, and the like of an object present around the vehicle 1. At this time, the acquisition unit 31 recognizes the position of the object as, for example, a position on an absolute coordinate system with a representative point of the vehicle 1 (for example, a center of gravity or a center of a drive shaft) as an origin. Accordingly, a relative position between the vehicle 1 and the object present around can be recognized. In the absolute coordinate system, the position of the object may be represented using a representative point such as a center of gravity or a corner of the object, or may be represented as a region.

For example, the acquisition unit 31 can acquire the peripheral information including an obstacle present around the vehicle 1. Here, as the obstacle, for example, another traffic participant (for example, another vehicle or a pedestrian) present around the vehicle 1, or a fallen object on a road is assumed.

Further, the acquisition unit 31 recognizes, for example, a position and an attitude of the vehicle 1 during the traveling. For example, the acquisition unit 31 acquires the position of the vehicle 1 by acquiring, from the image captured by the camera 111, a road division line around the vehicle 1 or a division line indicating a parking frame in a parking area or a parking position. Further, the acquisition unit 31 recognizes the position and the attitude of the vehicle 1 based on, for example, a deviation from the road division line or the division line of the parking frame, and an angle between the vehicle and the road division line or the division line of the parking frame. The acquisition unit 31 may recognize the position and the attitude of the vehicle 1 by recognizing a boundary of the road, including a road shoulder, a curb, a block wall, a guard rail, or the like, and a boundary of the parking area, without being limited to the road division line or the division line of the parking frame.

The reception unit 32 receives the designation of the parking position from the user of the vehicle 1. Specifically, the reception unit 32 receives an instruction signal which instructs an operation of the vehicle 1 and which is received from the user via the touch panel 22 of the navigation device 20. For example, when a predetermined parking position is designated by the user from candidates of the parking position displayed on the touch panel 22, the reception unit 32 receives a signal, which is output from the touch panel 22 due to the designation, as an instruction signal for parking the vehicle 1. In addition to being designated (that is, selected) by the user from the candidates of the parking position designated by the control device 30, the predetermined parking position may be determined by, for example, the user designating the parking position on a map displayed on the touch panel 22 of the navigation device 20 instead of being designated from the candidates.

The control unit 33 automatically moves the vehicle 1 to the predetermined parking position based on the acquired peripheral information of the vehicle 1 and the designated predetermined parking position. Specifically, the control unit 33 performs the drive control, the braking control, and the steering control of the vehicle 1 via the drive ECU 51, the braking ECU 61, and the EPS ECU 45, and performs automatic parking with the designated parking position as the target parking position.

When there is the vehicle stop request from the user of the vehicle 1 while the vehicle 1 is being moved to the designated parking position, the control unit 33 temporarily stops the vehicle 1 and brings the door of the vehicle 1 into the openable state. Here, regarding the vehicle stop request, for example, when the shift position Ps in the shift device of the vehicle 1 is the parking (P), that is, when the shift position Ps detected by the shift position sensor 53 is the parking (P), the control unit 33 determines that there is the vehicle stop request from the user. The case where there is such a vehicle stop request from the user is assumed to be, for example, based on the convenience of the user, the environment of the parking position, or the like. As the convenience of the user, for example, a case where the occupant in a passenger seat or a rear seat urgently wants to go to the toilet and thus cannot wait for completion of the automatic parking and a case where the occupant needs to get out of the vehicle, during the execution of the automatic parking are assumed. Further, as the environment of the parking position, for example, a case where a parking width at the parking position is narrow and a distance to another vehicle adjacent to the vehicle 1 is too short when the vehicle 1 is parked, making it difficult for the occupant to get off the vehicle, a case where there are puddles, muddy, or the like on the ground of the parking position, making it difficult for the occupant to get off the vehicle, and the like are assumed.

When there is the vehicle stop request from the user of the vehicle 1, the control unit 33 stops the vehicle 1 at a current position and brings the door into the openable state. That is, the control unit 33 temporarily stops the vehicle and interrupts the automatic parking that is being performed. Then, the control unit 33 unlocks the door of the vehicle 1 (that is, releases door lock) via the door lock ECU 91 of the door lock device 90, and the user can get off the vehicle 1. That is, when there is the vehicle stop request, the control unit 33 temporarily stops the vehicle 1, and the user can get out of the vehicle in a state where the movement of the vehicle 1 to the parking position is not completed. Accordingly, the user can get off the vehicle 1 without canceling the automatic parking.

When the vehicle 1 is stopped in response to the vehicle stop request from the user of the vehicle 1, in a case where a predetermined operation is received from the user, the control unit 33 resumes the movement of the vehicle 1 to the parking position. That is, in a case where a predetermined operation for resuming the interrupted automatic parking is received based on a function of the reception unit 32, the control unit 33 resumes the automatic parking and moves the vehicle 1 to the designated parking position. In such a situation, for example, a case where the automatic parking is resumed when the occupant goes out of the vehicle in a case where the occupant needs to get out of the vehicle to go to the toilet is assumed. The predetermined operation is, for example, an operation on the touch panel 22 of the navigation device 20 or an operation on an operation switch for automatic parking. When the predetermined operation is received from the user, the control unit 33 resumes the movement of the vehicle 1 to the parking position. That is, the automatic parking is resumed.

As a premise, when the vehicle 1 is being moved to the parking position, the control unit 33 controls the door of the vehicle 1 to the unopenable state until there is the vehicle stop request. That is, unless there is the vehicle stop request, the control unit 33 performs control to lock the door of the vehicle 1 via the door lock ECU 91 and the door is not opened by an operation of the user.

The notification control unit 34 provides predetermined notification to the user of the vehicle 1. For example, when the vehicle 1 is stopped in response to the vehicle stop request from the user of the vehicle 1 while the vehicle 1 is being moved to the parking position designated by the user, the notification control unit 34 notifies that the automatic parking of the vehicle 1 is interrupted. Specifically, the notification control unit 34 provides notification to display, on a display device such as the touch panel 22, a display indicating that the automatic parking is interrupted (for example, “The automatic parking is interrupted.”). Accordingly, for example, the user of the vehicle 1 can recognize that the automatic parking is interrupted by viewing the display.

When the vehicle 1 is stopped in response to the vehicle stop request of the user, the notification control unit 34 provides notification to prompt the above-described predetermined operation (in other words, notification to prompt resumption of the automatic parking). That is, the notification control unit 34 provides the notification to prompt the resumption of the movement of the vehicle 1 to the parking position when the movement of the vehicle 1 to the parking position designated by the user is not completed, after the automatic parking is temporarily interrupted. For example, the notification control unit 34 provides notification to display, on a display device such as the touch panel 22, a display prompting the resumption of automatic parking (for example, “Please resume the automatic parking.”). The notification may be provided simultaneously with the interruption of the automatic parking, or may be performed after a predetermined time (for example, 30 [sec]) has elapsed (that is, when the automatic parking is not resumed for a predetermined time).

When the user performs the operation of opening the door while the vehicle 1 is being moved to the parking position, the notification control unit 34 notifies means for interrupting the automatic parking of the vehicle 1. As described above, in the present embodiment, the control device 30 can interrupt the automatic parking during the execution of the automatic parking of the vehicle 1, but some users may not grasp the means for interrupting the automatic parking and may perform the operation of opening the door (for example, an operation of pulling the door handle). As described above, as the premise, when the vehicle 1 is being moved due to the automatic parking, the door of the vehicle 1 is controlled to the unopenable state unless there is the vehicle stop request. Therefore, when the user performs the operation of opening the door while the vehicle 1 is being moved to the parking position, the notification control unit 34 notifies the means for interrupting the automatic parking of the vehicle 1. For example, the notification control unit 34 provides notification to display, on a display device such as the touch panel 22, a display prompting the operation on the means for interruption (for example, “Please set the shift position Ps to the parking (P).”). Accordingly, for example, the user of the vehicle 1 can grasp the means for interrupting the automatic parking by viewing the display. Whether the operation of opening the door is performed is determined by, for example, the operation detection unit 125.

Regarding means for notifying the user by the notification control unit 34, the user may be notified via the speaker 23 of the navigation device 20 in addition to being notified by displaying on a display device such as the touch panel 22.

### Example of Processing Performed by Control Device

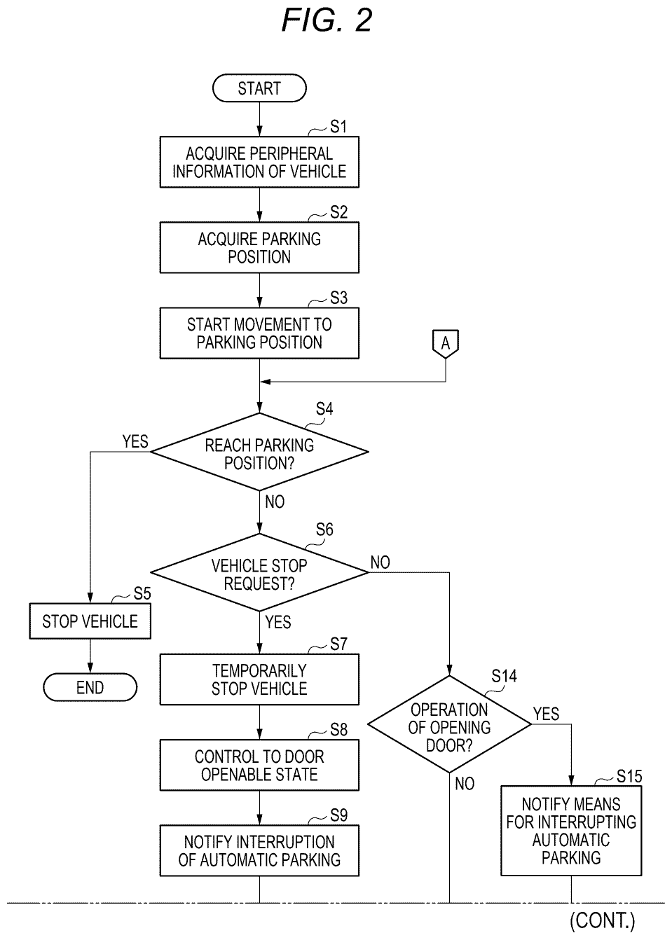

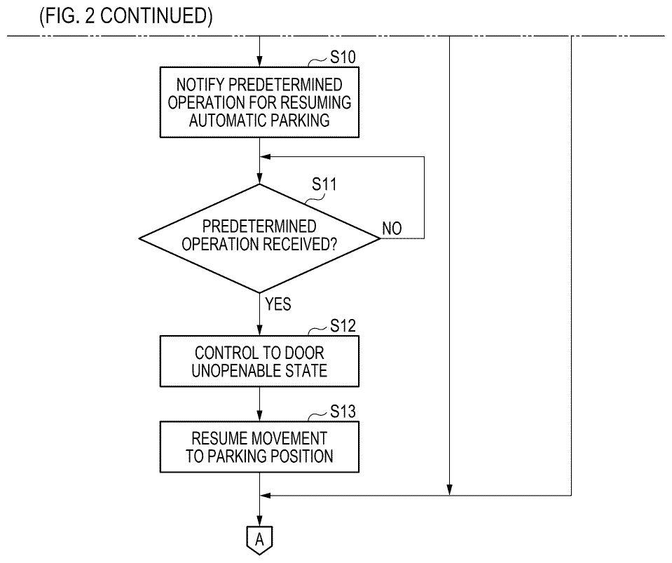

Next, an example of the parking assistance processing performed by the control device 30 will be described with reference to a flowchart. FIG. 2 is a flowchart showing an example of the processing, and the processing is performed, for example, when the operation switch for performing the automatic parking is turned on. As described above, when the automatic parking is to be started, the shift position Ps of the shift device is set to the parking (P), and when the automatic parking is started, the shift position Ps is set to the drive (D) or the reverse (R). Further, when the automatic parking is started, the door of the vehicle 1 is set to the unopenable state unless a predetermined operation is performed.

The control device 30 first acquires the peripheral information of the vehicle 1 (step S1). That is, the control device 30 recognizes the peripheral information acquired by the camera 111, the sonar 112, the radar 113, and the like based on a function of the acquisition unit 31.

Next, the control device 30 acquires the parking position of the vehicle 1 (step S2). That is, the control device 30 acquires the predetermined parking position designated by the user operating the touch panel 22 or the like, based on the function of the reception unit 32. The control device 30 receives a signal, which is output from the touch panel 22 due to the designation, as the instruction signal for parking the vehicle 1.

Next, the control device 30 starts moving the vehicle 1 to the parking position (step S3). That is, the control device 30 starts moving (automatically parking) the vehicle 1 to the parking position acquired in step S2, based on a function of the control unit 33. Specifically, the control device 30 performs the drive control, the braking control, and the steering control of the vehicle 1 via the drive ECU 51, the braking ECU 61, and the EPS ECU 45, and starts the automatic parking with the designated parking position as the target parking position.

Next, the control device 30 determines whether the vehicle 1 reaches the parking position based on the movement of the vehicle 1 started in step S3 (step S4). That is, the control device 30 determines whether the automatic parking is completed, based on the function of the control unit 33. For example, the control device 30 specifies the position and the attitude of the vehicle 1 based on the detection of the camera 111 or the like based on the function of the acquisition unit 31, and determines that the parking position is reached, that is, the automatic parking is completed, when the vehicle 1 is in the parking frame at designated the parking position and the attitude of the vehicle 1 is parallel to the line indicating the parking frame. When it is determined in step S4 that the vehicle 1 reaches the parking position (Yes in step S4), the control device 30 stops the vehicle 1 (step S5). That is, the control device 30 shifts the shift position Ps of the shift device to the parking (P) in order to complete the automatic parking of the vehicle 1. When the shift position Ps of the shift device is the parking (P), the control device 30 ends the processing of the flowchart shown in FIG. 2.

On the other hand, when it is determined in step S4 that the vehicle 1 does not reach the parking position (No in step S4), the control device 30 determines whether there is the vehicle stop request for the vehicle 1 (step S6). That is, the control device 30 determines, for example, whether the shift position Ps of the vehicle 1 is the parking (P) based on the function of the control unit 33, and proceeds the processing to step S7 when it is determined that the shift position Ps is the parking (P) (Yes in step S6). The shift position Ps is determined based on, for example, a signal input from the shift position sensor 53 to the control device 30.

In step S7, the control device 30 temporarily stops the vehicle 1. That is, the control device 30 stops the vehicle 1 at the current position based on the function of the control unit 33. Then, the control unit 33 controls the door of the vehicle 1 to the openable state (step S8). That is, based on the function of the control unit 33, the control device 30 unlocks the door of the vehicle 1 via the door lock ECU 91 of the door lock device 90, and the user can get off the vehicle 1.

Next, the control device 30 notifies that the execution of the automatic parking is interrupted (step S9). That is, based on a function of the notification control unit 34, the control device 30 notifies that the execution of the automatic parking is interrupted, for example, on a display device such as the touch panel 22.

Next, the control device 30 notifies a predetermined operation for resuming the interrupted automatic parking (step S10). That is, based on the function of the notification control unit 34, the control device 30 notifies a predetermined operation (for example, an operation on the touch panel 22 in the navigation device 20 or an operation on the operation switch for the automatic parking) for prompting the resumption of the automatic parking, for example, on a display device such as the touch panel 22. Then, the control device 30 determines whether the predetermined operation is received (step S11).

For example, when it is determined that the operation on the touch panel 22, the operation switch, or the like is not yet received (No in step S11), the control device 30 waits until the predetermined operation is received.

On the other hand, when it is determined that the operation on the touch panel 22, the operation switch, or the like is received (Yes in step S11), the control device 30 controls the door of the vehicle 1 to the unopenable state (step S12). That is, the control device 30 sets the door in the openable state in step S8 to the unopenable state in response to the reception of the predetermined operation for resuming the automatic parking. This is for achieving safety of the occupant or the like by disabling the opening of the door during the execution of the automatic parking.

Next, the control device 30 resumes the movement of the vehicle 1 to the parking position (step S13). That is, the control device 30 performs the drive control, the braking control, and the steering control of the vehicle 1 via the drive ECU 51, the braking ECU 61, and the EPS ECU 45 based on the function of the control unit 33, and resumes the automatic parking with the designated parking position as the target parking position. After resuming the movement of the vehicle 1 to the parking position, the control device 30 returns the processing to step S4.

On the other hand, when it is determined in step S6 that there is no vehicle stop request for the vehicle 1 from the user (No in step S6), the control device 30 determines whether the operation of opening the door of the vehicle 1 is performed (step S14). As described above, some users may not grasp the means for interrupting the automatic parking and may perform the operation of opening the door such as pulling the door handle. Therefore, when it is determined that the operation of opening the door is performed (Yes in step S14), the control device 30 proceeds the processing to step S15, and notifies the means for interrupting the automatic parking.

Specifically, in step S15, based on the function of the notification control unit 34, the control device 30 provides the notification by displaying, on a display device such as the touch panel 22, a display prompting the operation on the means for interrupting the automatic parking of the vehicle 1. Alternatively, the notification may be provided via the speaker 23. When it is determined in step S14 that the operation of opening the door is not performed (No in step S14), the control device 30 returns the processing to step S4.

As described above, in the present embodiment, when there is the vehicle stop request from the user during the execution of the automatic parking, the vehicle 1 is temporarily stopped, and the door of the vehicle 1 is set to the openable state. That is, when there is the vehicle stop request, the control device 30 stops the vehicle to interrupt the execution of the automatic parking, and releases the door lock via the door lock ECU 91, and the user such as the occupant can go out of the vehicle. Accordingly, for example, when the user wants to get out of the vehicle due to the convenience of the user such as going to the toilet, the environment of the parking position such as puddles at the parking position, or the like during the execution of the automatic parking, the user can get off the vehicle 1 without cancelling the automatic parking. By performing such processing, the control device 30 can further improve traffic safety and contribute to development of a sustainable transportation system.

In the present embodiment, in a case where a predetermined operation such as an operation on the touch panel 22 or an operation on the operation switch is received from the user when the vehicle is stopped in response to the vehicle stop request, the control device 30 resumes the interrupted movement to the parking position. Accordingly, for example, as compared with a configuration in which, when there is the vehicle stop request, the automatic parking is cancelled and performed again from initial processing, the user can be prevented from feeling troublesome due to performing the automatic parking from the initial processing. Further, since the automatic parking can be resumed from the same state as after the interruption, a processing load of the control device 30 can be reduced as compared with the case where the automatic parking is performed again from the initial processing.

In the present embodiment, the vehicle stop request is based on, for example, an operation of setting the shift position Ps of the shift device to the parking (P). Generally, when stopping the vehicle, the user operates the shift device to set the shift position Ps to the parking (P). Accordingly, even during the execution of the automatic parking, the user can make the vehicle stop request by such a simple operation.

In the present embodiment, when the vehicle 1 is being moved to the parking position, the control device 30 sets the door to the unopenable state until there is the vehicle stop request. Accordingly, for example, even if an operation of opening the door is performed while the vehicle 1 is being moved, the door is not opened, and thus the safety of the user as well as safety of the vehicle 1 or the like can be achieved.

In the present embodiment, when the vehicle 1 is stopped in response to the vehicle stop request from the user of the vehicle 1 while the vehicle 1 is being moved to the parking position, the control device 30 notifies, that the automatic parking is interrupted, via a display device such as the touch panel 22 or the speaker 23. Accordingly, the user can grasp that the execution of the automatic parking is interrupted in a current situation.

In the present embodiment, when the vehicle 1 is stopped in response to the vehicle stop request from the user, the control device 30 provides notification to prompt a predetermined operation (that is, notification to prompt the resumption of the automatic parking), via a display device such as the touch panel 22 or the speaker 23. Accordingly, for example, even if the user forgets to resume the automatic parking, the automatic parking can be resumed by receiving the notification.

In the present embodiment, when the user performs the operation of opening the door while the vehicle 1 is being moved to the parking position, the control device 30 notifies the means for interrupting the automatic parking, via a display device such as the touch panel 22 or the speaker 23. Accordingly, for example, even in a case where the user does not grasp the means for interrupting the automatic parking and performs the operation of opening the door, the user can grasp the means for interrupting the automatic parking by receiving the notification.

### Others

Although an embodiment of the present disclosure has been described above with reference to the drawings, it goes without saying that the present disclosure is not limited to the embodiment described above. It is apparent that those skilled in the art may conceive of various modifications and changes within the scope described in the claims, and it is understood that such modifications and changes naturally fall within the technical scope of the present disclosure.

For example, as an example of the vehicle stop request from the user, in addition to the case where the shift position Ps of the shift device is set to the parking (P), for example, a case where a side brake is applied may be assumed.

The control method described in the above embodiment may be implemented by executing a control program prepared in advance on a computer. The control program is stored in a computer-readable storage medium and executed by being read from the storage medium. In addition, the control program may be provided in a form stored in a non-transitory storage medium such as a flash memory, or may be provided via a network such as the Internet. The computer that executes the present control program may be provided in the control device, may be provided in an electronic device such as a smartphone, a tablet terminal, or a personal computer that can communicate with the control device, or may be provided in a server device that can communicate with the control device and the electronic device.

In the present specification, at least the following matters are described. Although corresponding constituent elements in the embodiment described above are shown in parentheses, the present disclosure is not limited thereto.

(1) A control device (control device 30) for automatically parking a vehicle (vehicle 1) to a predetermined parking position, the control device including:
an acquisition unit (acquisition unit 31) configured to acquire peripheral information of the vehicle;
a reception unit (reception unit 32) configured to receive designation of the parking position from a user of the vehicle; and
a control unit (control unit 33) configured to automatically move the vehicle to the parking position based on the acquired peripheral information and the designated parking position, in which
the control unit temporarily stops the vehicle and sets a door of the vehicle to an openable state from an unopenable state in response to s a vehicle stop request from the user of the vehicle while the vehicle is being moved to the parking position, and resumes moving the vehicle to the parking position in response to a predetermined operation being received from the user of the vehicle.

According to (1), for example, when the user wants to get out of the vehicle due to convenience of the user such as going to the toilet, an environment of the parking position such as puddles at the parking position, or the like during execution of the automatic parking, the user can get off the vehicle without cancelling the automatic parking. Further, by resuming the movement to the parking position when the predetermined operation is received from the user, for example, as compared with a configuration in which the automatic parking is cancelled and performed again from initial processing, the user can be prevented from feeling troublesome due to performing the automatic parking from the initial processing.

(2) The control device according to (1), in which
the vehicle stop request is an operation of setting a shift position (shift position Ps) of the vehicle to parking.

According to (2), when stopping the vehicle, the user normally operates a shift device to set the shift position to the parking, and thus the vehicle stop request may be made by such a simple operation even during execution of the automatic parking.

(3) The control device according to (1), in which
when the vehicle is being moved to the parking position, the control unit sets the door to the unopenable state until there is the vehicle stop request.

According to (3), for example, even if an operation of opening the door is performed while the vehicle is being moved, the door is not opened, and thus safety of the user as well as safety of the vehicle or the like may be achieved.

(4) The control device according to (1), further including:
a notification control unit (notification control unit 34) configured to provide predetermined notification to the user of the vehicle, in which
the notification control unit notifies that automatic parking for automatically parking the vehicle is interrupted when the vehicle is stopped in response to the vehicle stop request from the user of the vehicle while the vehicle is being moved to the parking position.

According to (4), the user can grasp that the execution of the automatic parking is interrupted in a current situation.

(5) The control device according to (1), further including:
a notification control unit configured to provide predetermined notification to the user of the vehicle, in which
the notification control unit (notification control unit 34) provides notification to prompt the predetermined operation when the vehicle is stopped in response to the vehicle stop request.

According to (5), for example, even if the user forgets to resume the automatic parking, the automatic parking may be resumed by receiving the notification.

(6) The control device according to (1), further including:
a notification control unit (notification control unit 34) configured to provide predetermined notification to the user of the vehicle, in which
the notification control unit notifies means for interrupting automatic parking for automatically parking the vehicle, when the user performs an operation of opening the door while the vehicle is being moved to the parking position.

According to (6), for example, even in a case where the user does not grasp the means for interrupting the automatic parking and performs the operation of opening the door, the user can grasp the means for interrupting the automatic parking by receiving the notification.

(7) A control method, using a computer, for automatically parking a vehicle (vehicle 1) to a predetermined parking position, the control method including:
acquiring peripheral information of the vehicle;
receiving designation of the parking position from a user of the vehicle;
automatically moving the vehicle to the parking position based on the acquired peripheral information and the designated parking position;
temporarily stopping the vehicle and setting a door of the vehicle to an openable state from an unopenable state in response to a vehicle stop request from the user of the vehicle while the vehicle is being moved to the parking position; and
resuming moving the vehicle to the parking position in response to a predetermined operation being received from the user of the vehicle.

According to (7), for example, when the user wants to get out of the vehicle due to convenience of the user such as going to the toilet, an environment of the parking position such as puddles at the parking position, or the like during execution of the automatic parking, the user can get off the vehicle without cancelling the automatic parking. Further, by resuming the movement to the parking position when the predetermined operation is received from the user, for example, as compared with a configuration in which the automatic parking is cancelled and performed again from initial processing, the user can be prevented from feeling troublesome due to performing the automatic parking from the initial processing.

(8) A non-transitory computer-readable storage medium storing a control program causing a computer to execute a process for automatically parking a vehicle (vehicle 1) to a predetermined parking position, the process including:
acquiring peripheral information of the vehicle;
receiving designation of the parking position from a user of the vehicle; and
automatically moving the vehicle to the parking position based on the acquired peripheral information and the designated parking position;
temporarily stopping the vehicle and setting a door of the vehicle to an openable state from an unopenable state in response to a vehicle stop request from the user of the vehicle while the vehicle is being moved to the parking position; and
resuming moving the vehicle to the parking position in response to a predetermined operation being received from the user of the vehicle.

According to (8), for example, when the user wants to get out of the vehicle due to convenience of the user such as going to the toilet, an environment of the parking position such as puddles at the parking position, or the like during execution of the automatic parking, the user can get off the vehicle without cancelling the automatic parking. Further, by resuming the movement to the parking position when the predetermined operation is received from the user, for example, as compared with a configuration in which the automatic parking is cancelled and performed again from initial processing, the user can be prevented from feeling troublesome due to performing the automatic parking from the initial processing.

What is claimed is:

1. A control device for automatically parking a vehicle to a predetermined parking position, the control device comprising:
an acquisition unit configured to acquire peripheral information of the vehicle;
a reception unit configured to receive designation of the parking position from a user of the vehicle; and
a control unit configured to automatically move the vehicle to the parking position based on the acquired peripheral information and the designated parking position, wherein
the control unit temporarily stops the vehicle and sets a door of the vehicle to an openable state from an unopenable state in response to s a vehicle stop request from the user of the vehicle while the vehicle is being moved to the parking position, and resumes moving the vehicle to the parking position in response to a predetermined operation being received from the user of the vehicle.

2. The control device according to claim 1, wherein
the vehicle stop request is an operation of setting a shift position of the vehicle to parking.

3. The control device according to claim 1, wherein
when the vehicle is being moved to the parking position, the control unit sets the door to the unopenable state until there is the vehicle stop request.

4. The control device according to claim 1, further comprising:
a notification control unit configured to provide predetermined notification to the user of the vehicle, wherein
the notification control unit notifies that automatic parking for automatically parking the vehicle is interrupted when the vehicle is stopped in response to the vehicle stop request from the user of the vehicle while the vehicle is being moved to the parking position.

5. The control device according to claim 1, further comprising:
a notification control unit configured to provide predetermined notification to the user of the vehicle, wherein
the notification control unit provides notification to prompt the predetermined operation when the vehicle is stopped in response to the vehicle stop request.

6. The control device according to claim 1, further comprising:
a notification control unit configured to provide predetermined notification to the user of the vehicle, wherein
the notification control unit notifies means for interrupting automatic parking for automatically parking the vehicle, when the user performs an operation of opening the door while the vehicle is being moved to the parking position.

7. A control method, using a computer, for automatically parking a vehicle to a predetermined parking position, the control method comprising:
acquiring peripheral information of the vehicle;
receiving designation of the parking position from a user of the vehicle;
automatically moving the vehicle to the parking position based on the acquired peripheral information and the designated parking position;
temporarily stopping the vehicle and setting a door of the vehicle to an openable state from an unopenable state in response to a vehicle stop request from the user of the vehicle while the vehicle is being moved to the parking position; and
resuming moving the vehicle to the parking position in response to a predetermined operation being received from the user of the vehicle.

8. A non-transitory computer-readable storage medium storing a control program causing a computer to execute a process for automatically parking a vehicle to a predetermined parking position, the process comprising:
acquiring peripheral information of the vehicle;
receiving designation of the parking position from a user of the vehicle; and
automatically moving the vehicle to the parking position based on the acquired peripheral information and the designated parking position;
temporarily stopping the vehicle and setting a door of the vehicle to an openable state from an unopenable state in response to a vehicle stop request from the user of the vehicle while the vehicle is being moved to the parking position; and
resuming moving the vehicle to the parking position in response to a predetermined operation being received from the user of the vehicle.
